(19) United States
(12) Patent Application Publication
(10) Pub. No.: US 2026/0154113 A1
(43) Pub. Date: Jun. 4, 2026

(54) NETWORK-ON-CHIP, DATA REDUCTION METHOD AND ELECTRONIC DEVICE

(71) Applicant: Lemon Inc., Grand Cayman (KY)

(72) Inventors: Chun LIU, Los Angeles, CA (US); Jun ZHENG, Los Angeles, CA (US)

(21) Appl. No.: 18/967,231

(22) Filed: Dec. 3, 2024

(51) Int. Cl. G06F 9/50

(52) U.S. Cl. CPC G06F 9/5027

(57) ABSTRACT

A network-on-chip, a data reduction method, and an electronic device are provided. The network-on-chip includes a plurality of routing nodes that are coupled, where each of a plurality of object routing nodes among the plurality of routing nodes includes a streaming reduction engine, each object routing node is coupled with a processing unit. The streaming reduction engine is configured to perform a reduction operation to obtain a reduction result on first data provided by a previous stage with respect to the streaming reduction engine and second data provided by an object processing unit, where the object processing unit is a processing unit among the plurality of processing units that is coupled to an object routing node where the streaming reduction engine is located; and provide the reduction result to a next stage with respect to the streaming reduction engine.

### TECHNICAL FIELD

Embodiments of the present disclosure relate to a network-on-chip, a data reduction method, and an electronic device.

### BACKGROUND

Data reduction is usually a cross-device operation that refers to performing a reduction operation on data of all devices and writing a result of the reduce operation to a specific device. The reduction operation refers to reducing a set of numbers to a smaller set through a function.

### SUMMARY

The section of Summary is provided to present conceptions in brief form, and the conceptions will be described in detail in the section of Detailed Description that follows. The section of Summary is not intended to identify key features or essential features of the technical solutions for which protection is claimed, nor is it intended to limit the scope of the technical solutions for which protection is claimed.

At least one embodiment of the present disclosure provides a network-on-chip, which includes a plurality of routing nodes that are coupled, where each of a plurality of object routing nodes among the plurality of routing nodes includes a streaming reduction engine, the plurality of object routing nodes are coupled one-to-one with a plurality of processing units, a plurality of streaming reduction engines included in the plurality of object routing nodes are cascaded, and the streaming reduction engine is configured to: perform a reduction operation to obtain a reduction result on first data provided by a previous stage with respect to the streaming reduction engine and second data provided by an object processing unit, where the object processing unit is a processing unit among the plurality of processing units that is coupled to an object routing node where the streaming reduction engine is located; and provide the reduction result to a next stage with respect to the streaming reduction engine.

At least one embodiment of the present disclosure provides a data reduction method, applied to a network-on-chip, where the network-on-chip includes plurality of routing nodes that are coupled, each of plurality of object routing nodes among the plurality of routing nodes includes a streaming reduction engine, the plurality of object routing nodes are coupled one-to-one with a plurality of processing units, and a plurality of streaming reduction engines included in the plurality of object routing nodes are cascaded, where the method includes: acquiring first data provided by a previous stage with respect to the streaming reduction engine and second data provided by an object processing unit, where the object processing unit is a processing unit among the plurality of processing units that is coupled to an object routing node where the streaming reduction engine is located; performing a reduction operation on the first data and the second data to obtain a reduction result; and providing the reduction result to a next stage with respect to the streaming reduction engine.

At least one embodiment of the present disclosure provides an electronic device, which includes the network-on-chip according to any embodiment of the present disclosure.

### BRIEF DESCRIPTION OF DRAWINGS

The above and other features, advantages, and aspects of the embodiments of the present disclosure will become more apparent with reference to the drawings and the following specific implementations. Throughout the drawings, identical reference numerals represent identical elements. It should be understood that the drawings are schematic and that originals and elements are not necessarily drawn to scale.

FIG. 1A shows a schematic diagram of a reduction operation;

FIG. 1B shows a schematic diagram of an all-reduce operation;

FIG. 1C shows a schematic diagram of a reduce-scatter operation;

FIG. 2 shows a schematic diagram of a network-on-chip;

FIG. 3 shows a schematic diagram of a partial structure of a network-on-chip according to at least one embodiment of the present disclosure;

FIG. 4 shows a schematic diagram of a streaming reduction engine according to at least one embodiment of the present disclosure;

FIG. 5 shows a structural schematic diagram of a network-on-chip according to at least one embodiment of the present disclosure;

FIG. 6 shows a structural schematic diagram of another network-on-chip according to at least one embodiment of the present disclosure;

FIG. 7 shows a flowchart of a data reduction method according to at least one embodiment of the present disclosure;

FIG. 8 shows a schematic diagram of an electronic device according to at least one embodiment of the present disclosure; and

FIG. 9 shows a schematic diagram of an electronic device according to at least one embodiment of the present disclosure.

### DETAILED DESCRIPTION

Embodiments of the present disclosure will be described in more detail below with reference to the drawings. Although some embodiments of the present disclosure are shown in the drawings, it should be understood, however, that the present disclosure may be implemented in various forms and should not be construed as being limited to the embodiments set forth herein, but rather are provided for a more thorough and complete understanding of the present disclosure. It should be understood that the drawings and embodiments of the present disclosure are for exemplary purposes only and are not intended to limit the scope of protection of the present disclosure.

It should be understood that the various steps described in the method embodiments of the present disclosure may be performed in a different order, and/or in parallel. In addition, the method embodiments may include additional steps and/or omit performing the illustrated steps. The scope of the present disclosure is not limited in this regard.

The term “include” and its variants as used herein mean open-ended inclusion, i.e., “including but not limited to”. The term “based on” is “based at least in part on”. The term “one embodiment” means “at least one embodiment”; the term “another embodiment” means “at least one additional embodiment”; and the term “some embodiments” means “at least some embodiments”. Relevant definitions of other terms will be given in the description below.

It should be noted that the concepts of “first”, “second” and the like mentioned in the present disclosure are only used to differentiate different apparatuses, modules or units, and are not used to limit the order or interdependent relationships of functions performed by these apparatuses, modules or units.

It should be noted that the modifications of “one” and “a plurality of” mentioned in the present disclosure are schematic rather than limiting, and persons skilled in the art should understand that, unless otherwise expressly stated in the context, they should be understood as “one or more”. “A plurality of” should be understood as two or more than two.

In the following description, the names of messages or information interacted between a plurality of apparatuses in the embodiments of the present disclosure are used for illustrative purposes only and are not intended to limit the scope of those messages or information.

Computer algorithms are based on a combination of function operations, and distributed training is usually adopted for training a model. Function operations applied to hardware for the distributed training usually include: broadcast, scatter, gather, all-gather, reduce, all-reduce, and reduce-scatter, etc.

Broadcast refers to broadcasting data on a root server (root rank) to all other servers (ranks). For example, one rank finishes calculating its own part of data and sends this part of data to all other ranks at the same time in the distributed training. This operation is called Broadcast.

Scatter refers to scattering the data on the root rank into equal-sized data blocks, and every other rank obtains one data block. For example, one rank finishes calculating its own part of data, but the data on this rank is too large, so it needs to divide the data on this rank into several equal-sized sub-data (buffer), and then send one of the data blocks to other ranks in accordance with a sequence (rank index). This operation is called Scatter.

Gather refers to directly splicing data blocks from other ranks, where the data blocks are acquired by the root rank. For example, after all the ranks perform scattering, each rank obtains one data block from another rank, and the operation of splicing together the data blocks obtained by one rank is called Gather.

All-gather refers to that all the ranks carry out the above operation of Gather, so respective ranks obtain the data of all the ranks. For example, all the ranks splice the data blocks they receive (all perform the operation of Gather). This is called All-gather.

Reduce refers to performing a reduction operation on the data of all the ranks and then writing the data to the root rank. All-reduce refers to performing a reduction operation on the data of all the ranks and then writing the data to all the ranks. Reduce-scatter refers to that one rank divides its data into equal-sized data blocks, and each of the ranks performs a reduction operation on the resulting data, i.e., a scatter operation is performed before the reduction operation.

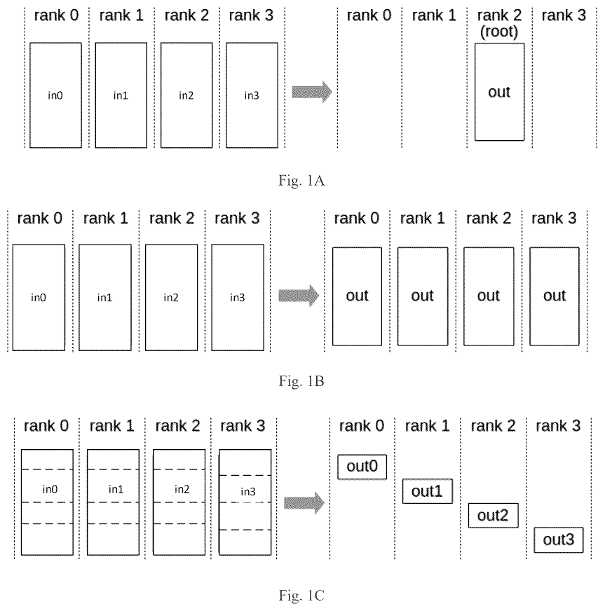

FIG. 1A shows a schematic diagram of a reduction operation; FIG. 1B shows a schematic diagram of an all-reduce operation; and FIG. 1C shows a schematic diagram of a reduce-scatter operation.

As shown in FIGS. 1A to 1C, the plurality of devices involved include rank0, rank1, rank2, and rank3.

As shown in FIG. 1A, when all the ranks (rank0 to rank3) perform a broadcast or scatter operation, a rank as a receiver (e.g., rank2) receives data from the respective ranks (rank0, rank1, and rank3), and the rank2 performs a certain reduction operation on the received data to obtain a result out before storing it in its own rank (rank2) memory. This operation is called the reduction operation.

As shown in FIG. 1B, each rank completes the reduction operation shown in FIG. 1A, which is called the all-reduction operation. That is, the rank0, rank1, rank2, and rank3 respectively perform the reduction operation on the received data to obtain the result out. The all-reduction operation is the most basic framework for distributed training. All the data are integrated into each rank through the reduction operation, and the respective ranks also obtain the completely consistent reduction data that contain the originally calculated parameters on all the ranks.

As shown in FIG. 1C, the scatter-reduce operation refers to scattering first, i.e., dividing data in one rank into equal-sized data blocks, and then reducing the sub-data obtained from each rank. This is similar to All-gather, except that the sub-data are not simply spliced together but undergo the reduction operation.

For example, each rank divides the data into four parts. For example, data in0 in rank0 is divided into 4 pieces of sub-data, and the rank0 provides one of the four pieces of sub-data to each of rank1 to rank3, so that each of the rank0 to rank3 obtains one different piece of sub-data of the data in0; similarly, data in1 in rank1 is divided into four pieces of sub-data, and each of the rank0 to rank3 obtains one different piece of sub-data of the data in1; data in2 in the rank2 is divided into four pieces of sub-data, each of the rank0 to rank3 obtains one different piece of sub-data of the data in2; data in3 in the rank3 is divided into four pieces of sub-data, and each of the rank1 to rank3 obtains one different piece of sub-data of the data in3. In this way, the rank0 obtains its own one piece of sub-data of the data in0, one piece of sub-data of the data in1, one piece of sub-data of the data in2, and one piece of sub-data of the data in3, and then the rank0 performs the reduction operation on the one sub-data of the data in0, the one piece of sub-data of the data in1, the one piece of sub-data of the data in2, and the one piece of sub-data of the data in3 to obtain out0. Similarly, the rank1 to rank3 also perform the reduction operation on the four pieces of sub-data obtained by themselves to obtain out1, out2 and out3, respectively.

As the number of processor cores increases, a System-On-Chip (SoC) has shown the development trend from multi-core to many-core. In a many-core system, global interconnections may lead to a severe on-chip synchronization error, an unpredictable communication delay, and huge power consumption overhead. In order to alleviate these conflicts, the concept of Network-on-Chip (NoC) has been proposed, which may replace the traditional bus interconnect or point-to-point interconnect. Thus, the Network-on-Chip becomes a new on-chip communication architecture.

The network-on-chip typically includes resource nodes (also called “processing units”), routing nodes, and a topological structure. The resource nodes may refer to various functional modules, such as microprocessors, DSP cores, and specialized hardware resources. The routing nodes are the main component of the NOC, and their main task is to receive a packet from a port and decide which destination to forward it to (either a next routing node or a final destination address) based on a destination address included therein. The topological structure refers to the distribution of routing nodes and the way they are connected to each other in the network-on-chip, and determines routing methods, arbitration methods, mapping mechanisms, etc. in a network. Usually, the routing nodes may be coupled to the resource nodes so as to route data from the resource nodes to the destination address. The topological structure includes, for example, a 2D mesh structure and a 2D torus structure. In a network-on-chip having the 2D mesh structure, for example, each routing node is connected to four nearest neighbors, i.e., is directly connected to routing nodes located above, below, at the left and at the right of a current routing node. A network-on-chip having the 2D torus structure is similar to that having the 2D mesh structure, except that the routing nodes, located at the edges on both sides, of the network-on-chip having the 2D torus structure are coupled to form a loop.

At present, data reduction is less efficient in terms of bandwidth utilization, has a higher demand on buffers required by the routing node. A complete reduction operation needs a long time.

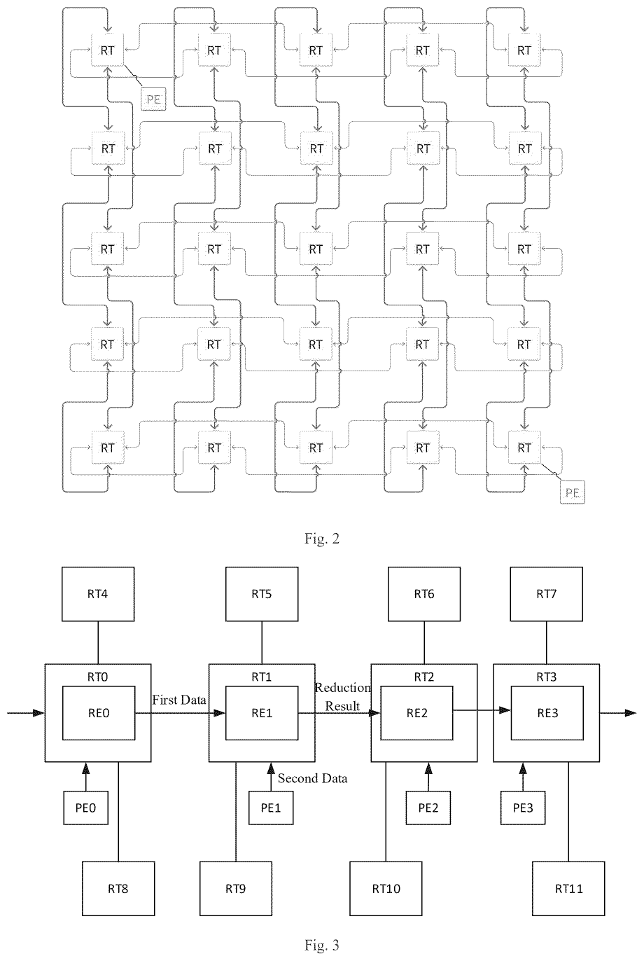

FIG. 2 shows a schematic diagram of a network-on-chip.

As shown in FIG. 2, the network-on-chip 200 includes a plurality of routing nodes RT. For example, at least some of the plurality of routing nodes RT are coupled to a processing unit PE. The plurality of routing nodes RT form, for example, a 2D ring topological structure.

In this 2D ring topological structure, the routing nodes RT may be coupled to routing nodes that are spaced apart by 1 routing node, and a routing node located at a rightmost edge is coupled to an adjacent routing node on the left, thereby forming a loop; similarly, a routing node located at a lowermost edge is coupled to an adjacent routing node on the top, thereby forming a loop.

It should be noted that, for simplicity, FIG. 2 shows only some of the processing units PE, while more processing units PE may be included in the actual network-on-chip.

Data generated by the plurality of processing units PE of the network-on-chip shown in the figure may perform the distributed training described in FIGS. 1A to 1C. In the network-on-chip, function operations applied to hardware for the distributed training as described above typically involve copying or exchanging data from the plurality of processing units PE into one or more processing units PE, and then performing, for example, the reduction operation, in a specific processing unit PE. This processing results in low bandwidth utilization, high demand on buffers required by the routing nodes, and a long time required for a complete reduction operation.

At least one embodiment of the present disclosure provides a network-on-chip. The network-on-chip includes a plurality of routing nodes that are coupled, and each of a plurality of object routing nodes among the plurality of routing nodes includes a streaming reduction engine. The plurality of object routing nodes are coupled one-to-one with a plurality of processing units, the plurality of streaming reduction engines included in the plurality of object routing nodes are cascaded. The streaming reduction engine is configured to: perform a reduction operation to obtain a reduction result on first data provided by a previous stage with respect to the streaming reduction engine and second data provided by an object processing unit, where the object processing unit is a processing unit among the plurality of processing units that is coupled to an object routing node where the streaming reduction engine is located; and provide the reduction result to a next stage with respect to the streaming reduction engine. The network-on-chip of the above embodiment of the present disclosure enables the data to be subjected to the reduction operation in the routing nodes in a stream manner, thereby improving the bandwidth utilization, reducing the demand for buffers required by the routing nodes, and saving the time to perform the reduction operation.

FIG. 3 shows a schematic diagram of a partial structure of a network-on-chip according to at least one embodiment of the present disclosure. It should be noted that the block diagram illustrated in FIG. 3 is only a part of the network-on-chip, and the network-on-chip of the embodiment of the present disclosure may include more routing nodes, and may employ a variety of available topological structures.

As shown in FIG. 3, the network-on-chip includes a plurality of routing nodes (e.g., routing nodes RT0 to RT11) that are coupled. At least some of the plurality of routing nodes each include a streaming reduction engine, which are also referred to in this disclosure as “object routing nodes”. For example, in the example of FIG. 3, the object routing nodes include a routing node RT0, a routing node RT1, a routing node RT2, and a routing node RT3. The routing node RT0, the routing node RT1, the routing node RT2, and the routing node RT3 each include a streaming reduction engine and is coupled to a processing unit, respectively.

For example, the routing node RT0 includes a streaming reduction engine RE0 and is coupled to a processing unit PE0; the routing node RT1 includes a streaming reduction engine RE1 and is coupled to a processing unit PE1; the routing node RT2 includes a streaming reduction engine RE0 and is coupled to a processing unit PE2; and the routing node RT3 includes a streaming reduction engine RE3 and is coupled to a processing unit PE3.

The streaming reduction engine in the routing node described above is configured to: perform a reduction operation to obtain a reduction result on first data provided by a previous stage with respect to the streaming reduction engine and second data provided by an object processing unit, where the object processing unit is a processing unit among the plurality of processing units that is coupled to an object routing node where the streaming reduction engine is located; and provide the reduction result to a next stage with respect to the streaming reduction engine.

In some embodiments of the present disclosure, the previous stage with respect to the streaming reduction engine may be one of the cascaded streaming reduction engines. For example, in the example of FIG. 3, the streaming reduction engines RE0 to RE3 are cascaded to form a streaming reduction engine link. The previous stage with respect to the streaming reduction engine RE1 is the streaming reduction engine RE0, the previous stage with respect to the streaming reduction engine RE2 is the streaming reduction engine RE1, and the previous stage with respect to the streaming reduction engine RE3 is the streaming reduction engine RE2.

In some embodiments of the present disclosure, the previous stage with respect to the streaming reduction engine may be a device that directly provides data, which may be an external device, such as an external processing unit and a graphics processing unit, coupled to the network-on-chip but independent of the network-on-chip. For example, if the streaming reduction engine is a first-stage streaming reduction engine, the previous stage with respect to the first-stage streaming reduction engine may be the first data provided by the external device.

In addition, for the first-stage streaming reduction engine, the first data may be provided directly to the next stage (i.e., a second-stage streaming reduction engine). For example, the streaming reduction engine RE0 provides the first data directly to the streaming reduction engine RE1. It should be noted that the streaming reduction engine RE0 is the first stage in that streaming reduction engine link, but the streaming reduction engine RE0 may be a second stage, a third stage, etc., in other streaming reduction engine links. That is, each streaming reduction engine may be involved in more than one streaming reduction engine link and participate in the computation of more than one streaming reduction engine link.

For example, in the streaming reduction engine link formed by cascading the streaming reduction engines RE0 to RE3, the streaming reduction engine RE0 is the first stage, and the previous stage with respect to the streaming reduction engine RE0 may be the external device.

For example, the streaming reduction engine provided in some embodiments of the present disclosure is illustrated using the streaming reduction engine RE1 as an example. For example, the processing unit coupled to the routing node RT0 where the streaming reduction engine RE1 is located is an object processing unit PE1. The streaming reduction engine RE1 receives first data provided from the previous stage (i.e., the streaming reduction engine RE0) and second data provided by the object processing unit PE1, and the streaming reduction engine RE1 performs a reduction operation on the first data and the second data to obtain a reduction result, and then provides the reduction result to the next stage (i.e., the streaming reduction engine RE2).

In some embodiments of the present disclosure, the reduction operation includes, for example, at least one of the following operations: adding, subtracting, maximizing, solving AND, OR and XOR, minimizing, etc. Accordingly, the processing unit described in the present disclosure for performing the reduction operations includes, but is not limited to, processing circuits for performing the operations of adding, subtracting, maximizing, solving AND, OR and XOR, minimizing, and the like, and may include, for example, an adder, etc.

In some embodiments of the present disclosure, the streaming reduction engine of the last-stage may store the reduction result into its own buffer, or provide the reduction result to the external device, or forward the reduction result to other routing nodes.

In some embodiments of the present disclosure, it may be that each routing node includes a streaming reduction engine such that the entire network-on-chip may perform the reduction operation in a stream manner, or it may be that some of the routing nodes include a streaming reduction engine. That is, embodiments of the present disclosure do not limit the number of object routing nodes.

In some embodiments of the present disclosure, the plurality of streaming reduction engines may be cascaded in a manner following the topological structure of the plurality of routing nodes. For example, if the plurality of routing nodes is a 1D ring or a 2D ring topological structure, then the plurality of streaming reduction engines are also cascaded in accordance with the 1D ring, the 2D ring, etc.

In some other embodiments of the present disclosure, the plurality of streaming reduction engines are cascaded in a manner different from the topological structure of the plurality of routing nodes. For example, the plurality of routing nodes are of the 2D mesh topological structure, but the plurality of streaming reduction engines may be cascaded in a 2D ring. The cascaded plurality of streaming reduction engines may, for example, be adjacent or non-adjacent. For example, streaming reduction engines in the same column are cascaded and streaming reduction engines in the same row are cascaded. Embodiments of the present disclosure do not specifically limit the cascading manner of the plurality of streaming reduction engines.

For example, as shown in FIG. 3, the streaming reduction engine RE0, the streaming reduction engine RE1, the streaming reduction engine RE2, and the streaming reduction engines RE3 are cascaded, then data generated by the object processing unit PE0, the object processing unit PE1, the object processing unit PE2, and the object processing unit PE3 forms data streams in the streaming reduction engine RE0, the streaming reduction engine RE1, the streaming reduction engine RE2, and the streaming reduction engine RE3, and the reduction operation is performed as the data is transmitted as a stream. For example, the processing unit PE0 generates data a0 and receives data V from the previous stage, and the streaming reduction engine RE0 performs the reduction operation on the data V and the data a0 to obtain a reduction result a, which is then provided to the streaming reduction engine RE1. For the streaming reduction engine RE1, the data a is provided by the streaming reduction engine RE0 to the streaming reduction engine RE1, where the data a is an example of the first data. The streaming reduction engine RE1 calculates a reduction result c of the data a and data b that is generated by the processing unit PE1, for example, c=a+b, where the data b is an example of second data. Then, the streaming reduction engine RE1 provides the reduction result c to the streaming reduction engine RE2, and the streaming reduction engine RE2 calculates a reduction result e of the reduction result c and data d that is generated by the processing unit PE2, for example, e=c+d. Then, the streaming reduction engine RE2 provides data e to the streaming reduction engine RE3, and the streaming reduction engine RE3 calculates a reduction result g of the data e and data f that is generated by the processing unit PE3. The reduction result g is a result obtained by performing a complete reduction operation by the object processing unit PE0, the object processing unit PE1, the object processing unit PE2, and the object processing unit PE3. Therefore, in some embodiments of the present disclosure, data generated by a plurality of processing units that are required to perform the reduction operation are computed while being transmitted in the routing nodes in a stream manner, instead of the way that all the data are transmitted to a target processing unit (e.g., the object processing unit PE3) and then subjected to the reduction operation by the target processing unit, thereby saving the bandwidth, improving the efficiency of the reduction operation, and saving the time needed for the reduction operation.

In another embodiment of the present disclosure, the first-stage streaming reduction engine RE0 may also provide the generated data directly to the second-stage streaming reduction engine RE1, i.e., the data generated by the processing unit PE0 coupled to the first-stage streaming reduction engine RE0 (e.g., the generated data a) is directly provided to the next stage.

For performing a reduction operation using four routing nodes, the bandwidth required in the above embodiments of the present disclosure is 50% of the bandwidth required in the related technology (in which the reduction operation is performed after all the data are transmitted to the target processing unit). This is because, for the four routing nodes, in the related technology, the transmission of the data a to the processing unit PE3 needs 3 bandwidths (i.e., the bandwidth required for transmitting the data a from RE0 to RE1, the bandwidth required from RE1 to RE2 and the bandwidth required from RE2 to RE3); the transmission of the data b to the processing unit PE3 needs 2 bandwidths (i.e., the bandwidth required for transmitting the data b from RE1 to RE2 and the bandwidth required from RE2 to RE3); the transmission of the data c needs 1 bandwidth (i.e., the bandwidth required for transmitting the data c from RE2 to RE3), and therefore, a total of 6 bandwidth are needed. For the above embodiments of the present disclosure, only 3 bandwidths are needed (i.e., the bandwidth required for transmitting the data a from RE0 to RE1, the bandwidth required for transmitting the data c from RE1 to RE2 and the bandwidth required for transmitting the data e from RE2 to RE3). Therefore, the bandwidth required in the above embodiments of the present disclosure is 50% of the bandwidth required in the related technology. That is, the percentage of the bandwidth required in the above embodiments of the present disclosure to the bandwidth required in the related technology is (N−1)/((N−1+1)*(N−1)/2)=2/N, and accordingly, the space saved in the above embodiments of the present disclosure relative to the bandwidth required in the related technology is (1−2/N)=(N−2)/N, where N is the number of routing nodes and N is an integer greater than 2.

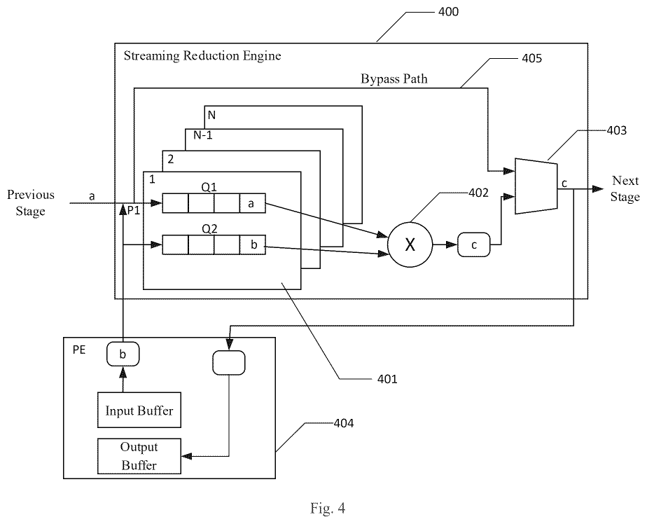

FIG. 4 shows a schematic diagram of a streaming reduction engine according to at least one embodiment of the present disclosure.

As shown in FIG. 4, a streaming reduction engine 400 includes a storage circuit 401, a reduction circuit 402, and an output end 403.

The storage circuit 401 includes a first queue and a second queue. The first queue is coupled to the previous stage and configured to receive first data, and the second queue is coupled to the object processing unit 404 and configured to receive second data. For example, the storage circuit 401 includes a queue Q1 and a queue Q2, the queue Q1 is coupled to the previous stage, the queue Q2 is coupled to the object processing unit 404, the queue Q1 is an example of the first queue, and the queue Q2 is an example of the second queue.

The reduction circuit 402 is coupled to the storage circuit 401 and is configured to acquire the first data and the second data from the storage circuit 401 and perform a reduction operation on the first data and the second data to obtain the reduction result.

The output end 403 is coupled to the reduction circuit 402 and is configured to provide the reduction result to a next stage with respect to the streaming reduction engine.

For example, in the example of FIG. 4, the previous stage provides data a (an example of the first data) to the streaming reduction engine 400, and the data a enters the queue Q1; the object processing unit 404 provides data b (an example of the second data) to the streaming reduction engine 400, and the data b enters the queue Q2, so that there is data in both the queue Q1 and the queue Q2, and the reduction circuit 402 acquires the data a and the data b, respectively, from the queue Q1 and the queue Q2, and then performs the reduction operation on the data a and the data b. For example, the reduction circuit 402 performs a sum operation on the data a and the data b to obtain a reduction result c. The reduction circuit 402 provides the reduction result c to the output end 403, and the output end 403 outputs the reduction result c. In some embodiments of the present disclosure, the output end 403 may provide the reduction result c to the next stage with respect to the streaming reduction engine 400, or may provide the reduction result c to the object processing unit 404 coupled to the streaming reduction engine 400. For example, the output end 403 is further configured to provide output data to an object processing unit coupled to the streaming reduction engine in response to the streaming reduction engine being the last stage, where the output data is, for example, the reduction result. For example, the object processing unit 404 receives the reduction result c provided by the output end 403 and stores the reduction result c in its own output buffer. For example, if the object processing unit 404 is the root rank for this reduction operation or the streaming reduction engine 400 is the last stage, the output end 403 provides the reduction result c to the object processing unit 404. If the streaming reduction engine 400 is not the last stage, the output end 403 provides the reduction result c to the next stage.

In some embodiments of the present disclosure, the reduction circuit 402 may, for example, access the queue Q1 and the queue Q2 simultaneously, thereby acquiring the first data and the second data from the queue Q1 and queue Q2 simultaneously; or it may also access the queue Q1 and the queue Q2 sequentially, thereby acquiring the first data and the second data sequentially. The first data and the second data are present in pairs. If the reduction circuit 402 obtains only one of the first data or the second data, it does not perform the reduction operation. The reduction operation is performed only when the first data and the second data are obtained in pairs from the queue Q1 and the queue Q2. For example, the reduction circuit 402 acquires the first data and the second data in accordance with indexes of the queue Q1 and the queue Q2, where the data with the same index is a pair of data; if the reduction circuit 402 obtains the first data and the second data with the same index from the queue Q1 and the queue Q2, it performs the reduction operation.

In some embodiments of the present disclosure, the streaming reduction engine further includes a bypass path, the output end is further coupled to the bypass path, and the bypass path is configured to bypass the storage circuit and the reduction circuit to directly provide object data to the output end, where the object data is from the previous stage or the object processing unit. The output end is further configured to receive the object data and provide the object data to the next stage with respect to the streaming reduction engine. In these embodiments, the bypass path allows for a reduction operation on the data selectively, thus improving the flexibility of the reduction operation.

For example, in the example of FIG. 4, the streaming reduction engine 400 includes a bypass path 405, and the output end 403 is further coupled to the bypass path 405. For example, the bypass path 405 refers to bypassing the storage circuit 401 and the reduction circuit 402 by coupling an input end P1 of the storage circuit 401 directly to the output end 403. The bypass path 405 provides the object data from the previous stage or the object data from the object processing unit 404 directly to the output end 403 such that no reduction operation is performed on the object data. That is, in some embodiments of the present disclosure, the object data is data that is not provided for a reduction operation at the present stage with respect to the streaming reduction engine 400. In response to the streaming reduction engine being the last stage, the output end 403 may provide the object data to an object processing unit coupled to the streaming reduction engine.

For example, if data F provided by the previous stage with respect to the streaming reduction engine 400 is not provided for a reduction operation at the streaming reduction engine 400, but rather the next stage with respect to the streaming reduction engine 400 performs a reduction operation, the data F directly enters the next stage with respect to the streaming reduction engine 400 via the bypass path 405. As another example, if data G generated by the object processing unit 404 is not provided for a reduction operation at a local routing node, the data G is directly output to the next stage with respect to the streaming reduction engine 400 via the bypass path.

In some embodiments of the present disclosure, for example, the output end 403 includes a multiplexer. Two input ends of the multiplexer are coupled to the bypass path 405 and the reduction circuit 402, respectively, and the multiplexer is configured to select to output either the object data provided by the bypass path 405 or the reduction result provided by the reduction circuit 402.

In some embodiments of the present disclosure, each routing node includes a routing apparatus (e.g., a router or a routing circuit) in addition to the streaming reduction engine for performing the reduction operation. The routing apparatus determines a routing path for data and determines whether the data is subject to the reduction operation at a local routing node based on a data packet delivered in the routing node. If an instruction in the data packet instructs performing a reduction operation on the data at the local routing node, the data obtained from the previous stage and the data provided by the object processing unit enter the first queue and the second queue in the storage circuit. If the instruction in the data packet instructs not performing a reduction operation on the data at the local routing node, the data obtained from the previous stage and the data provided by the object processing unit enter the bypass path 405.

In some embodiments of the present disclosure, the storage circuit is configured to store N queue pairs, the N queue pairs include a first queue pair, and the first queue pair includes a first queue and a second queue. The N queue pairs are in one-to-one correspondence with N data streams, and each of the N data streams is a data stream formed by the plurality of streaming reduction engines sequentially performing the reduction operation, N being a positive integer.

The first queue pair is any one of the N queue pairs, each of which is used for storing the first data and the second data of the N data streams.

In some embodiments of the present disclosure, as shown in FIG. 4, the storage circuit 401 includes queue pairs 1 to N, each queue pair including two queues for storing the first data and the second data, respectively. The queue pairs and the data streams use global indexes, i.e., a data stream with an index 0 enters a queue pair with the index 0; a data stream with an index 1 enters a queue pair with the index 1, and the like.

In the above embodiments, a plurality of data streams use a plurality of queue pairs to perform the scatter-reduce operation. When all the data streams are ended, the execution of the scatter-reduce operation is completed, which can reduce data blocking and make full use of the bandwidth.

In some embodiments of the present disclosure, final reduction values of the N data streams are stored to the object processing units corresponding to the N streaming reduction engines, and the final reduction values are reduction results obtained by performing the reduction operation in the streaming reduction engine of the last-stage. For example, a final reduction value OUT[0] of the data stream with the index 0 is stored to the object processing unit with number 0, the final reduction value OUT[1] of the data stream with the index 1 is stored to the object processing unit with number 1, and the like, so as to complete the scatter-reduce operation. For example, the streaming reduction engines corresponding to the object processing unit PE0, the object processing unit PE1, the object processing unit PE2, and the object processing unit PE3 respectively form a ring, the processing unit PE3 provides a final reduction value of A00+A01+A02+A03 to the streaming reduction engine corresponding to the processing unit PE0, and in response to receiving the final reduction value, the streaming reduction engine corresponding to the processing unit PE0 stores the value to an output buffer of processing unit PE0 via a bypass path.

In some embodiments of the present disclosure, the first queue and the second queue are allocated with a first number of tokens, and the tokens are configured in such a way that the number of the tokens decreases in response to the queue pair receiving the first data and the second data, and the number of the tokens increases in response to the reduction circuit reading the first data and the second data from the queue pair. The first queue and the second queue are configured to determine whether or not to receive new data based on the number of the tokens and the first number. Queue congestion is prevented by means of the first number of tokens.

For example, the first number is 5, i.e., there are 5 tokens allocated to each queue, and each time the queue acquires a piece of data, one token is consumed, and if the reduction circuit removes a piece of data from the queue each time, the current number of tokens is increased by one. That is, the current number of tokens indicates the number of data that the queue can receive. If the number of remaining tokens is 0, the queue no longer receives new data.

In some embodiments of the present disclosure, each of the plurality of object routing nodes is configured to, in response to an execution error of the reduction operation by the streaming reduction engine, re-execute the reduction operation from the first stage with respect to the plurality of streaming reduction engines.

For example, if the object routing node finds that a data error or packet loss is encountered, the reduction operation is re-executed from the first stage with respect to the streaming reduction engines. The method can simplify the handling of situations such as encountering the data error or packet loss.

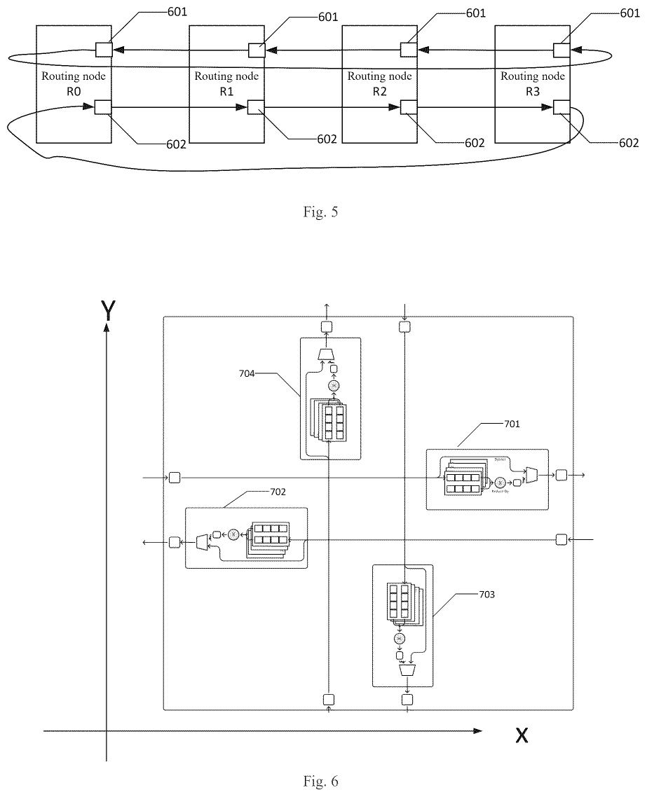

FIG. 5 shows a structural schematic diagram of a network-on-chip according to at least one embodiment of the present disclosure.

As shown in FIG. 5, a plurality of routing nodes in the network-on-chip are coupled according to a one-dimensional ring topological structure. Each of the plurality of object routing nodes includes two streaming reduction engines that operate in opposite data-transmission directions, respectively.

For example, each object routing node includes a streaming reduction engine 601 and a streaming reduction engine 602, and the streaming reduction engine 601 and the streaming reduction engine 602 operate in opposite data-transmission directions, respectively, i.e., the data streams flow in opposite directions. For example, a flow direction of a data stream formed by four streaming reduction engines 602 is routing node R0-routing node R1-routing node R2-routing node R3-routing node R0; a flow direction of a data stream formed by four streaming reduction engines 601 is routing node R3-routing node R2-routing node R1-routing node R0-routing node R3.

FIG. 6 shows a structural schematic diagram of another network-on-chip according to at least one embodiment of the present disclosure.

In the example of FIG. 6, a plurality of routing nodes are coupled according to a two-dimensional structure. For example, the plurality of routing nodes are coupled according to a two-dimensional mesh topological structure or coupled according to a two-dimensional ring topological structure.

In this embodiment, each of the plurality of object routing nodes includes, in each dimension, two streaming reduction engines that operate in opposite data-transmission directions.

FIG. 6 exemplarily shows an embodiment of the distribution of streaming reduction engines in routing nodes. As shown in FIG. 6, the routing nodes may route data in the X-axis and Y-axis, i.e., the network-on-chip is of the two-dimensional topological structure. A streaming reduction engine 701 and a streaming reduction engine 702 are included in an X-axis direction for transmitting data in two opposite directions, respectively. For example, the streaming reduction engine 701 transmits data to a routing node on the right side; the streaming reduction engine 702 transmits data to a routing node on the left side. A streaming reduction engine 703 and a streaming reduction engine 704 are included in a Y-axis direction for transmitting data in two opposite directions, respectively. For example, the streaming reduction engine 703 transmits data to a lower routing node; the streaming reduction engine 704 transmits data to an upper routing node.

In the embodiments shown in FIGS. 5 and 6, each of the plurality of object routing nodes includes, in each dimension, two streaming reduction engines that operate in opposite data-transmission directions, enabling the utilization of bi-directional bandwidth, with each direction carrying half of the total traffic. For example, if there is a streaming reduction engine in one direction only in each dimension, data in each processing unit is divided into four pieces of sub-data; if there are streaming reduction engines in two directions in each dimension, the data in each processing unit may be divided into eight pieces of sub-data, and each direction carries the reduction operation of four data streams, thereby improving the work efficiency by utilizing the bi-directional bandwidth.

In the network-on-chip having the two-dimensional topological structure, when the streaming reduction engine on the Y-axis performs a scatter-reduce operation on one set of data, the streaming reduction engine on the X-axis may perform a scatter-reduce operation on another set of data.

In some embodiments of the present disclosure, the streaming reduction engine may be provided in all routing directions of the routing node, and the present disclosure is not limited thereto.

Some embodiments of the present disclosure provide a data reduction method applied to a network-on-chip. The network-on-chip includes a plurality of routing nodes that are coupled, each of a plurality of object routing nodes among the plurality of routing nodes includes a streaming reduction engine, the plurality of object routing nodes are coupled one-to-one with a plurality of processing units, and a plurality of streaming reduction engines included in the plurality of object routing nodes are cascaded. For example, the data reduction method is applied to the network-on-chip provided in any embodiment of the present disclosure.

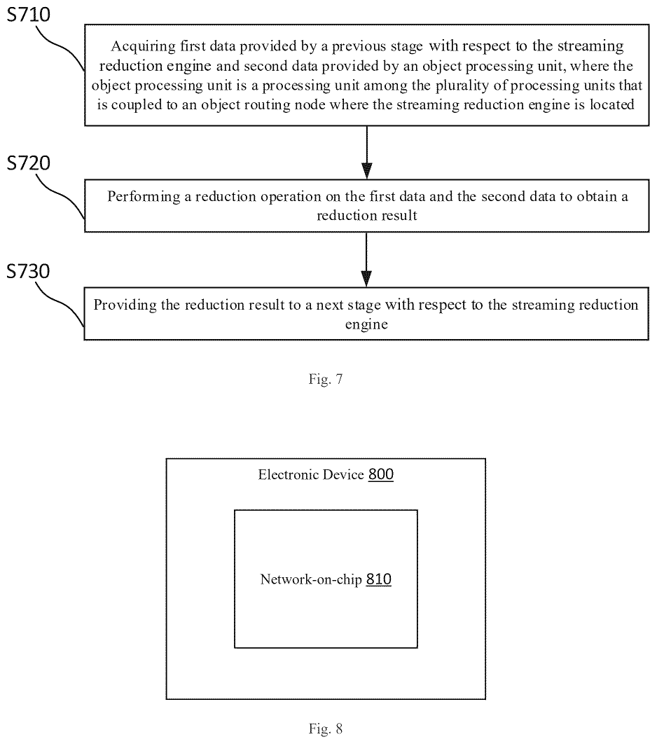

FIG. 7 shows a flowchart of a data reduction method according to at least one embodiment of the present disclosure.

As shown in FIG. 7, the data reduction method includes S710 to S730.
S710: acquiring first data provided by a previous stage with respect to the streaming reduction engine and second data provided by an object processing unit, where the object processing unit is a processing unit among the plurality of processing units that is coupled to an object routing node where the streaming reduction engine is located.
S720: performing a reduction operation on the first data and the second data to obtain a reduction result.
S730: providing the reduction result to a next stage with respect to the streaming reduction engine.

The data reduction method enables the data to be subjected to the reduction operation in the routing nodes in a stream manner, thus improving the bandwidth utilization, and saving the time for performing the reduction operation.

For the step S710, for example, in the example of FIG. 3, the streaming reduction engines RE0 to RE3 are cascaded. For example, the streaming reduction engine RE1 acquires the first data provided by the streaming reduction engine RE0 and the second data provided by the processing unit PE1 coupled to the streaming reduction engine RE1.

For the step S720, for example, the streaming reduction engine RE1 performs the reduction operation on the first data and the second data, for example, the reduction operation includes any of adding, subtracting, maximizing, solving AND, OR and XOR, and minimizing. For example, the streaming reduction engine RE1 calculates a sum of the first data and the second data.

For the step S730, for example, the streaming reduction engine RE1 provides the sum of the first data and the second data to the streaming reduction engine RE2.

In some embodiments of the present disclosure, the method further includes that the first stage with respect to the plurality of streaming reduction engines only provides the first data to the second stage, where the first data is provided, for example, by an object processing unit coupled to an object routing node where the first stage is located. Alternatively, the first data provided by a previous stage with respect to the first-stage streaming reduction engine refers to the directly input data rather than data from the RE in the previous stage, such that the first-stage streaming reduction engine performs the reduction operation on the first data and the second data. The directly input data is, for example, data provided by the external device. Similarly, the streaming reduction engine of the last-stage may store the reduction result into its own buffer, or provide the reduction result to the external device, or forward the reduction result to other routing nodes.

In some embodiments of the present disclosure, the method further includes: bypassing the storage circuit and the reduction circuit to provide object data directly to the output end, where the object data is from the previous stage or the object processing unit.

The steps of the data reduction method correspond to the respective units or modules of the foregoing network-on-chip, and reference is made to the description of the network-on-chip above for the implementation of the data reduction method.

At least one embodiment of the present disclosure provides an electronic device that includes the network-on-chip provided in any embodiment of the present disclosure.

FIG. 8 shows a schematic diagram of an electronic device 800 according to at least one embodiment of the present disclosure.

As shown in FIG. 8, the electronic device 800 includes a network-on-chip 810. The network-on-chip 810 may be a network-on-chip provided in any of the embodiments of the present disclosure, as can be seen in the description above and will not be repeated herein.

The electronic device enables the data to be subjected to a reduction operation in the routing nodes in a stream manner, thus improving the bandwidth utilization and saving the time for performing the reduction operation.

In the above, the network-on-chip, the data reduction method, and the electronic device provided in the embodiments of the present disclosure are described in conjunction with the drawings. The data reduction method provided in the embodiments of the present disclosure enables data to be subjected to the reduction operation in the routing node in a stream manner, thus improving the bandwidth utilization and saving the time for performing the reduction operation.

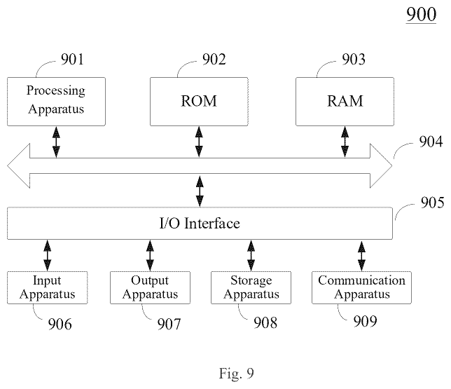

FIG. 9 shows a schematic diagram of an electronic device 900 according to at least one embodiment of the present disclosure.

A terminal in the embodiments of the present disclosure may include, but is not limited to, a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and a fixed terminal such as a digital TV, a desktop computer, or the like. The electronic device illustrated in FIG. 9 is merely an example and should not impose any limitations on the function and scope of application of the embodiments of the present disclosure.

As shown in FIG. 9, the electronic device 900 may include a processing apparatus 901 (e.g., a central processing unit and a graphics processing unit). The processing apparatus 901 may include a multi-core processor in the network-on-chip according to at least one embodiment of the present disclosure.

The processing apparatus 901 may perform various appropriate actions and processes based on a program stored in a read-only memory (ROM) 902 or loaded from a storage apparatus 908 into a random access memory (RAM) 903 according to the embodiments of the present disclosure. Also stored in the RAM 903 are various programs and data necessary for operations of the electronic device 900. The processing apparatus 901, the ROM 902, and the RAM 903 are interconnected by means of a bus 904. An input/output (I/O) interface 905 is also connected to the bus 904.

Typically, the following apparatuses may be connected to the I/O interface 905: an input apparatus 906 including, for example, a touch screen, a touch pad, a keyboard, a mouse, a camera, a microphone, an accelerometer, a gyroscope, and the like; an output apparatus 907 including, for example, a liquid crystal display (LCD), a loudspeaker, a vibrator, and the like; a storage apparatus 908 including, for example, a magnetic tape, and a hard disk; and a communication apparatus 909. The communication apparatus 909 may allow the electronic device 900 to wireless-communicate or wire-communicate with other devices to exchange data. Although the electronic device 900 with various apparatuses is illustrated in FIG. 9, it should be understood that it is not required to implement or have all of the illustrated apparatuses. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 909 and installed, or may be installed from the storage apparatus 908, or may be installed from the ROM 902. When the computer program is executed by the processing apparatus 901, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a multiple forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network reduction currently known or to be researched and developed in the future such as hypertext transfer reduction (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The computer-readable medium described above may be contained in the electronic device described above; or it may stand alone and not be assembled into that electronic device.

The computer-readable medium carries one or more programs that, when the one or more programs are executed by the electronic device, cause the electronic device to: acquire first data provided by a previous stage and second data provided by an object processing unit, where the object processing unit is a processing unit among the plurality of processing units that is coupled to an object routing node where the streaming reduction engine is located; perform a reduction operation on the first data and the second data to obtain a reduction result; and provide the reduction result to a next stage with respect to the streaming reduction engine.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. The name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, [Example 1] provides a network-on-chip, the network-on-chip includes a plurality of routing nodes that are coupled, where each of a plurality of object routing nodes among the plurality of routing nodes includes a streaming reduction engine, the plurality of object routing nodes are coupled one-to-one with a plurality of processing units, a plurality of streaming reduction engines included in the plurality of object routing nodes are cascaded, and the streaming reduction engine is configured to: perform a reduction operation to obtain a reduction result on first data provided by a previous stage and second data provided by an object processing unit, where the object processing unit is a processing unit among the plurality of processing units that is coupled to an object routing node where the streaming reduction engine is located; and provide the reduction result to a next stage with respect to the streaming reduction engine.

According to one or more embodiments of the present disclosure, [Example 2] the streaming reduction engine includes: a storage circuit, including a first queue and a second queue, where the first queue is coupled to the previous stage and configured to receive the first data, and the second queue is coupled to the object processing unit and configured to receive the second data; a reduction circuit, coupled to the storage circuit and configured to acquire the first data and the second data from the storage circuit and perform the reduction operation on the first data and the second data to obtain the reduction result; and an output end, coupled to the reduction circuit and configured to provide the reduction result to the next stage with respect to the streaming reduction engine.

According to one or more embodiments of the present disclosure, [Example 3] the streaming reduction engine further includes a bypass path, the output end is further coupled to the bypass path, the bypass path is configured to bypass the storage circuit and the reduction circuit to directly provide object data to the output end, where the object data is from the previous stage or the object processing unit, and the output end is further configured to receive the object data and provide the object data to the next stage with respect to the streaming reduction engine.

According to one or more embodiments of the present disclosure, [Example 4] the object data is data that is not provided for the reduction operation at a present stage with respect to the streaming reduction engine.

According to one or more embodiments of the present disclosure, [Example 5] the storage circuit is configured to store N queue pairs, the N queue pairs include a first queue pair, and the first queue pair includes the first queue and the second queue; the N queue pairs are in one-to-one correspondence with N data streams, and each of the N data streams is a data stream formed by the plurality of streaming reduction engines sequentially performing the reduction operation, N being a positive integer.

According to one or more embodiments of the present disclosure, [Example 6] data in each of the plurality of processing units coupled to the plurality of streaming reduction engines is divided into a plurality pieces of sub-data, the plurality pieces of sub-data are allocated with indexes, and a plurality pieces of sub-data with a same index in the plurality of object processing units undergo the reduction operation sequentially in the plurality of streaming reduction engines.

According to one or more embodiments of the present disclosure, [Example 7] final reduction values of the N data streams are stored to the object processing units corresponding to the N streaming reduction engines respectively, and the final reduction values are reduction results obtained by performing the reduction operation in a streaming reduction engine of a last-stage.

According to one or more embodiments of the present disclosure, [Example 8] the first queue and the second queue are allocated with a first number of tokens, the tokens are configured in such a way that a number of the tokens decreases in response to a queue pair receiving the first data and the second data, and the number of the tokens increases in response to the reduction circuit reading the first data and the second data from the queue pair, and the first queue and the second queue are configured to determine whether or not to receive new data based on the number of the tokens and the first number.

According to one or more embodiments of the present disclosure, [Example 9] the output end is further configured to provide the reduction result or the object data to the object processing unit coupled to the streaming reduction engine in response to the streaming reduction engine being a last stage.

According to one or more embodiments of the present disclosure, [Example 10] the plurality of routing nodes are coupled according to a one-dimensional ring topological structure, and each of the plurality of object routing nodes includes two streaming reduction engines that operate in opposite data-transmission directions, respectively.

According to one or more embodiments of the present disclosure, [Example 11] the plurality of routing nodes are coupled according to a two-dimensional structure, each of the plurality of object routing nodes includes, in each dimension, two streaming reduction engines that operate in opposite data-transmission directions.

According to one or more embodiments of the present disclosure, [Example 12] each of the plurality of object routing nodes is configured to: in response to an execution error of the reduction operation by the streaming reduction engine, re-execute the reduction operation from a first stage with respect to the plurality of streaming reduction engines.

According to one or more embodiments of the present disclosure, [Example 13] the reduction operation includes at least one of operations: adding, subtracting, maximizing, solving AND, OR and XOR, and minimizing.

According to one or more embodiments of the present disclosure, [Example 14] provides a data reduction method, applied to a network-on-chip, where the network-on-chip includes plurality of routing nodes that are coupled, each of plurality of object routing nodes among the plurality of routing nodes includes a streaming reduction engine, the plurality of object routing nodes are coupled one-to-one with a plurality of processing units, and a plurality of streaming reduction engines included in the plurality of object routing nodes are cascaded, where the method includes: acquiring first data provided by a previous stage and second data provided by an object processing unit, where the object processing unit is a processing unit among the plurality of processing units that is coupled to an object routing node where the streaming reduction engine is located; performing a reduction operation on the first data and the second data to obtain a reduction result; and providing the reduction result to a next stage with respect to the streaming reduction engine.

According to one or more embodiments of the present disclosure, [Example 15] provides an electronic device, which includes the network-on-chip according to any embodiment of the present disclosure.

The foregoing are merely descriptions of some embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, although operations have been described in a particular order, it shall not be construed as requiring that such operations are performed in the stated specific order or sequence. Under certain circumstances, multitasking and parallel processing may be advantageous. Similarly, although some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

What is claimed:

1. A network-on-chip, comprising a plurality of routing nodes that are coupled,
wherein each of a plurality of object routing nodes among the plurality of routing nodes comprises a streaming reduction engine, the plurality of object routing nodes are coupled one-to-one with a plurality of processing units, a plurality of streaming reduction engines comprised in the plurality of object routing nodes are cascaded, and
the streaming reduction engine is configured to:
perform a reduction operation to obtain a reduction result on first data provided by a previous stage with respect to the streaming reduction engine and second data provided by an object processing unit, wherein the object processing unit is a processing unit among the plurality of processing units that is coupled to an object routing node where the streaming reduction engine is located; and
provide the reduction result to a next stage with respect to the streaming reduction engine.

2. The network-on-chip of claim 1, wherein the streaming reduction engine comprises:
a storage circuit, comprising a first queue and a second queue, wherein the first queue is coupled to the previous stage and configured to receive the first data, and the second queue is coupled to the object processing unit and configured to receive the second data;
a reduction circuit, coupled to the storage circuit and configured to acquire the first data and the second data from the storage circuit and perform the reduction operation on the first data and the second data to obtain the reduction result; and
an output end, coupled to the reduction circuit and configured to provide the reduction result to the next stage with respect to the streaming reduction engine.

3. The network-on-chip of claim 2, wherein the streaming reduction engine further comprises a bypass path, the output end is further coupled to the bypass path,
the bypass path is configured to bypass the storage circuit and the reduction circuit to directly provide object data to the output end, wherein the object data is from the previous stage or the object processing unit, and
the output end is further configured to receive the object data and provide the object data to the next stage with respect to the streaming reduction engine.

4. The network-on-chip of claim 3, wherein the object data is data that is not provided for the reduction operation at a present stage with respect to the streaming reduction engine.

5. The network-on-chip of claim 2, wherein the storage circuit is configured to store N queue pairs, the N queue pairs comprise a first queue pair, and the first queue pair comprises the first queue and the second queue;
the N queue pairs are in one-to-one correspondence with N data streams, and each of the N data streams is a data stream formed by the plurality of streaming reduction engines sequentially performing the reduction operation, N being a positive integer.

6. The network-on-chip of claim 5, wherein data in each of the plurality of processing units coupled to the plurality of streaming reduction engines is divided into a plurality pieces of sub-data, the plurality pieces of sub-data are allocated with indexes, and a plurality pieces of sub-data with a same index in the plurality of object processing units undergo the reduction operation sequentially in the plurality of streaming reduction engines.

7. The network-on-chip of claim 6, wherein final reduction values of the N data streams are stored to the object processing units corresponding to the N streaming reduction engines respectively, and the final reduction values are reduction results obtained by performing the reduction operation in a streaming reduction engine of a last-stage.

8. The network-on-chip of claim 2, wherein the first queue and the second queue are allocated with a first number of tokens,
the tokens are configured in such a way that a number of the tokens decreases in response to a queue pair receiving the first data and the second data, and the number of the tokens increases in response to the reduction circuit reading the first data and the second data from the queue pair, and
the first queue and the second queue are configured to determine whether or not to receive new data based on the number of the tokens and the first number.

9. The network-on-chip of claim 3, wherein the output end is further configured to provide the reduction result or the object data to the object processing unit coupled to the streaming reduction engine in response to the streaming reduction engine being a last stage.

10. The network-on-chip of claim 1, wherein the plurality of routing nodes are coupled according to a one-dimensional ring topological structure, and
each of the plurality of object routing nodes comprises two streaming reduction engines that operate in opposite data-transmission directions, respectively.

11. The network-on-chip of claim 1, wherein the plurality of routing nodes are coupled according to a two-dimensional structure,
each of the plurality of object routing nodes comprises, in each dimension, two streaming reduction engines that operate in opposite data-transmission directions.

12. The network-on-chip of claim 1, wherein each of the plurality of object routing nodes is configured to: in response to an execution error of the reduction operation by the streaming reduction engine, re-execute the reduction operation from a first stage with respect to the plurality of streaming reduction engines.

13. The network-on-chip of claim 1, wherein the reduction operation comprises at least one of operations:
adding, subtracting, maximizing, solving AND, OR and XOR, and minimizing.

14. A data reduction method, applied to a network-on-chip, wherein the network-on-chip comprises plurality of routing nodes that are coupled, each of plurality of object routing nodes among the plurality of routing nodes comprises a streaming reduction engine, the plurality of object routing nodes are coupled one-to-one with a plurality of processing units, and a plurality of streaming reduction engines comprised in the plurality of object routing nodes are cascaded,
wherein the method comprises:
acquiring first data provided by a previous stage with respect to the streaming reduction engine and second data provided by an object processing unit, wherein the object processing unit is a processing unit among the plurality of processing units that is coupled to an object routing node where the streaming reduction engine is located;
performing a reduction operation on the first data and the second data to obtain a reduction result; and
providing the reduction result to a next stage with respect to the streaming reduction engine.

15. An electronic device, comprising a network-on-chip, wherein the network-on-chip comprises a plurality of routing nodes that are coupled,
wherein each of a plurality of object routing nodes among the plurality of routing nodes comprises a streaming reduction engine, the plurality of object routing nodes are coupled one-to-one with a plurality of processing units, a plurality of streaming reduction engines comprised in the plurality of object routing nodes are cascaded, and
the streaming reduction engine is configured to:
perform a reduction operation to obtain a reduction result on first data provided by a previous stage with respect to the streaming reduction engine and second data provided by an object processing unit, wherein the object processing unit is a processing unit among the plurality of processing units that is coupled to an object routing node where the streaming reduction engine is located; and
provide the reduction result to a next stage with respect to the streaming reduction engine.

16. The electronic device of claim 15, wherein the streaming reduction engine comprises:
a storage circuit, comprising a first queue and a second queue, wherein the first queue is coupled to the previous stage and configured to receive the first data, and the second queue is coupled to the object processing unit and configured to receive the second data;
a reduction circuit, coupled to the storage circuit and configured to acquire the first data and the second data from the storage circuit and perform the reduction operation on the first data and the second data to obtain the reduction result; and
an output end, coupled to the reduction circuit and configured to provide the reduction result to the next stage with respect to the streaming reduction engine.

17. The electronic device of claim 16, wherein the streaming reduction engine further comprises a bypass path, the output end is further coupled to the bypass path,
the bypass path is configured to bypass the storage circuit and the reduction circuit to directly provide object data to the output end, wherein the object data is from the previous stage or the object processing unit, and
the output end is further configured to receive the object data and provide the object data to the next stage with respect to the streaming reduction engine.

18. The electronic device of claim 17, wherein the object data is data that is not provided for the reduction operation at a present stage with respect to the streaming reduction engine.

19. The electronic device of claim 16, wherein the storage circuit is configured to store N queue pairs, the N queue pairs comprise a first queue pair, and the first queue pair comprises the first queue and the second queue;
the N queue pairs are in one-to-one correspondence with N data streams, and each of the N data streams is a data stream formed by the plurality of streaming reduction engines sequentially performing the reduction operation, N being a positive integer.

20. The electronic device of claim 19, wherein data in each of the plurality of processing units coupled to the plurality of streaming reduction engines is divided into a plurality pieces of sub-data, the plurality pieces of sub-data are allocated with indexes, and a plurality pieces of sub-data with a same index in the plurality of object processing units undergo the reduction operation sequentially in the plurality of streaming reduction engines.
